(19) United States
(12) Patent Application Publication
(10) Pub. No.: US 2025/0389152 A1
(43) Pub. Date: Dec. 25, 2025

(54) INTERIOR FIBERGLASS DOORS AND METHODS OF MAKING THE SAME

(71) Applicant: Steves & Sons, Inc., San Antonio, TX (US)

(72) Inventors: Scott LOVETT, LaVernia, TX (US); Austin PAYNE, Adkins, TX (US); Gregory WYSOCK, Huntley, IL (US)

(73) Assignee: Steves & Sons, Inc., San Antonio, TX (US)

(21) Appl. No.: 18/750,733

(22) Filed: Jun. 21, 2024

(51) Int. Cl. E06B 3/70

(52) U.S. Cl. CPC E06B 3/7001; E06B 3/7015; E06B 2003/7023; E06B 2003/7067

(57) ABSTRACT

This disclosure is directed to an interior fiberglass door and methods of manufacturing the same. The interior fiberglass door can include first and second fiberglass doorskins attached to first and second sides of a frame, respectively. Each of the first and second fiberglass doorskins can include an outer portion and a panel portion recessed from the outer portion. The interior fiberglass door can include a spacer between the panel portions of the first and second fiberglass doorskins and foam between the outer portions of the first and second fiberglass doorskins. Each of the first and second fiberglass doorskins can include a sticking transition between the outer portion and the panel portion, the sticking transition defining an angle relative to a plane of the outer portion of greater than about 70 degrees.

### FIELD

This disclosure relates to interior doors made using fiberglass doorskins.

### BACKGROUND

A major concern in interior door design is aesthetic appeal. Other important concerns for interior doors include sound reduction and temperature control. Traditionally, wood or wood composites have been preferred for providing enhanced aesthetics while reducing sound and heat propagation. Shaker doors, a common interior door design, are traditionally manufactured using wood to create well-defined panel and stile boundaries. It can be difficult to match the aesthetic qualities of wood interior doors using materials other than wood.

### BRIEF SUMMARY

In some embodiments, an interior door can include a frame having first and second sides and defining outer lateral sides of the interior door; first and second fiberglass doorskins attached to the first and second sides of the frame, respectively, each doorskin comprising an outer portion and a panel portion recessed from the outer portion; a spacer between the panel portions of the first and second fiberglass doorskins; and foam between the outer portions of the first and second doorskins.

In some embodiments, a method of manufacturing an interior shaker door using fiberglass can include attaching an outer portion of a first fiberglass doorskin to a frame; disposing a spacer adjacent a panel portion of the first fiberglass doorskin, the panel portion of the first fiberglass doorskin being recessed relative to the outer portion of the first fiberglass doorskin; disposing foam adjacent the outer portion of the first fiberglass doorskin between the frame and the spacer; and attaching an outer portion of a second fiberglass doorskin to the frame, wherein the spacer and the foam are between the first and second fiberglass doorskins.

### BRIEF DESCRIPTION OF THE DRAWINGS

The accompanying figures, which are incorporated herein, form part of the specification and illustrate embodiments of this disclosure. Together with the description, the figures further serve to explain the principles of and to enable a person skilled in the relevant arts to make and use the invention.

FIG. 1 depicts a front or rear view of an exemplary door according to some embodiments.

FIG. 2 depicts an exploded view of the exemplary door of FIG. 1, according to some embodiments.

FIG. 3 depicts a cross-sectional view of the exemplary door of FIG. 1, taken along line 3-3, according to some embodiments.

FIG. 4A depicts a front or rear view of an exemplary door according to some embodiments.

FIG. 4B depicts a cross-sectional view of the exemplary door of FIG. 4A, taken along line 4B-4B, according to some embodiments.

FIG. 5A depicts a front or rear view of an exemplary door according to some embodiments.

FIG. 5B depicts a cross-sectional view of the exemplary door of FIG. 5A, taken along line 5B-5B, according to some embodiments.

FIG. 6 depicts a front or rear view of the exemplary door of FIG. 1, according to some embodiments.

FIG. 7 depicts a front or rear view of the exemplary door of FIG. 4A, according to some embodiments.

FIG. 8 depicts a front or rear view of the exemplary door of FIG. 5A, according to some embodiments.

FIG. 9 depicts a method of manufacturing a door according to some embodiments.

FIG. 10 depicts a method of manufacturing a door according to some embodiments.

### DETAILED DESCRIPTION

Embodiments of the present invention will now be described in detail with reference to embodiments thereof as illustrated in the accompanying drawings. References to “one embodiment,” “an embodiment,” “an example embodiment,” “some embodiments,” “exemplary,” etc., indicate that the embodiment described can include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

Unless clearly indicated to the contrary (e.g., “either x or y, but not both x and y”) or readily contextually apparent, the term “or” as used herein is inclusive (i.e., “x or y” includes just x, just y, and x and y, and “x, y, or z” includes just x, just y, just z, and any combination thereof). Moreover, such phrases are not necessarily referring to the same embodiment.

The term “about” or “substantially” or “approximately” as used herein means the value of a given quantity that can vary based on a particular technology. Based on the particular technology, the term “about” or “substantially” or “approximately” can indicate a value of a given quantity that varies within, for example, 0.1-10% of the value (e.g., ±0.1%, ±1%, ±2%, ±5%, or ±10% of the value).

Numerical values, including endpoints of ranges, can be expressed herein as approximations preceded by the term “about,” “substantially,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint. Additionally, it will be further understood that a range expressed as “between” “X” and “Y” includes any value interposed by X and Y as well as X and Y.

The term “invention” or “present invention” as used herein is a non-limiting term and is not intended to refer to any single embodiment of the particular invention but encompasses all possible embodiments as described in the application.

As used herein, the term “fiberglass” refers to any composite material reinforced with glass fibers. Accordingly, “fiberglass” doorskins can include doorskins formed from any composite material that includes glass fibers. This can include any glass reinforced plastic (GRP) or sheet molding compound (SMC) that includes glass fibers. SMC can include glass fibers embedded in a resin matrix. Common materials that make up the resin matrix include vinyl ester, polyester, and/or epoxy. SMC can be purchased in rolls or sheets and formed into various parts (e.g., doorskins) via compression molding.

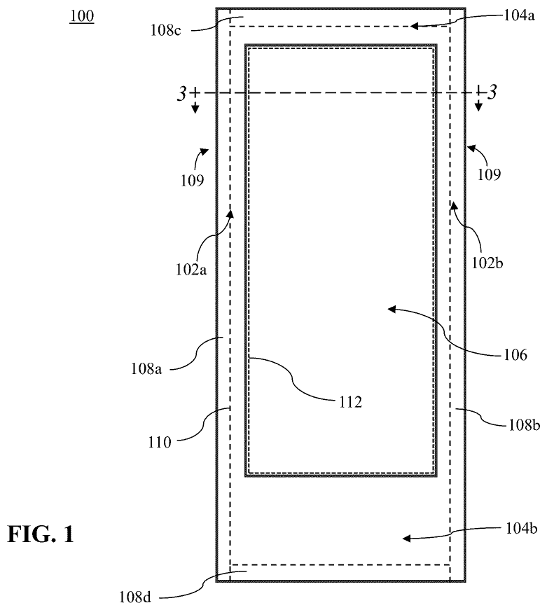

FIG. 1 shows a door 100 according to some embodiments. Door 100 can be an interior door having front and rear sides. Door 100 can include first stile 102a and second stile 102b. Door 100 can also include first rail 104a and second rail 104b. First rail 104a can be a top rail and second rail 104b can be a bottom rail. The stiles 102 and rails 104 can surround a panel 106, which can be recessed from stiles 102 and rails 104. In some embodiments, door 100 is a shaker-style door having one or more recessed panels.

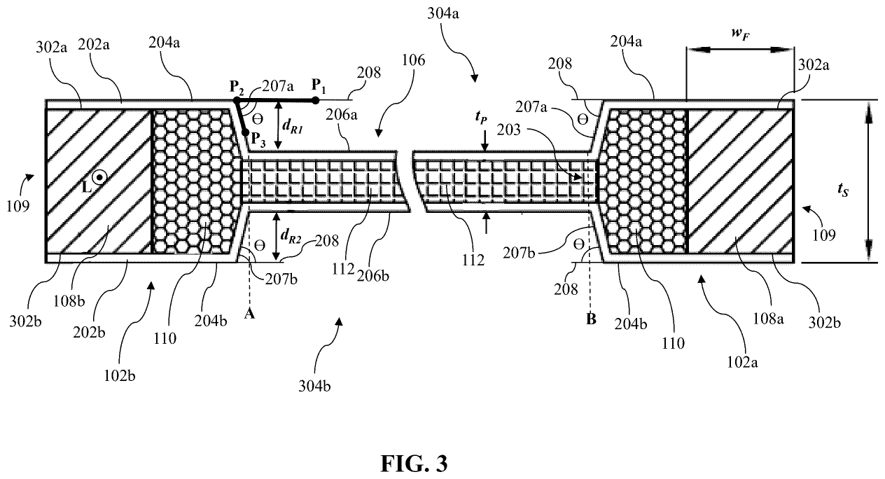

Door 100 can also include a frame 108 that provides the structural support for the door. In some embodiments, frame 108 can define the outer lateral sides 109 of door 100. In some embodiments, as shown in FIG. 3, frame 108 can define outermost lateral sides of door 100. Frame 108 can include one or more frame members. In some embodiments, frame 108 includes a first frame member 108a, a second frame member 108b, a third frame member 108c, and a fourth frame member 108d. First and second frame members 108a, 108b can be disposed within stiles 102a, 102b, respectively. Third and fourth frame members 108c, 108d can be disposed within rails 104a, 104b, respectively. In some embodiments, frame members 108a-d can be attached to one another using an adhesive and/or screws, nails, bolts, brackets, etc. In some embodiments, frame members 108a-d can be attached to one another using finger joints or dovetail joints. In some embodiments, frame 108 can be a single, integral unit formed from wood, a wood composite, or a rigid synthetic polymer. In such embodiments, frame members 108a-d can describe various portions of the integral frame 108. And in some embodiments, frame members 108a-d are not attached to each other.

In some embodiments, frame 108, including for example frame members 108a-d, can comprise wood. In some embodiments, frame 108 can comprise solid wood. In some embodiments, frame 108 can comprise a wood composite, for example laminated veneer lumber (LVL). However, frame 108 can comprise any type of wood or wood composite, including for example, finger jointed wood or fiberwood. In some embodiments, frame 108 can comprise a synthetic polymer, for example, polyvinyl chloride (PVC) or acrylonitrile butadiene styrene (ABS).

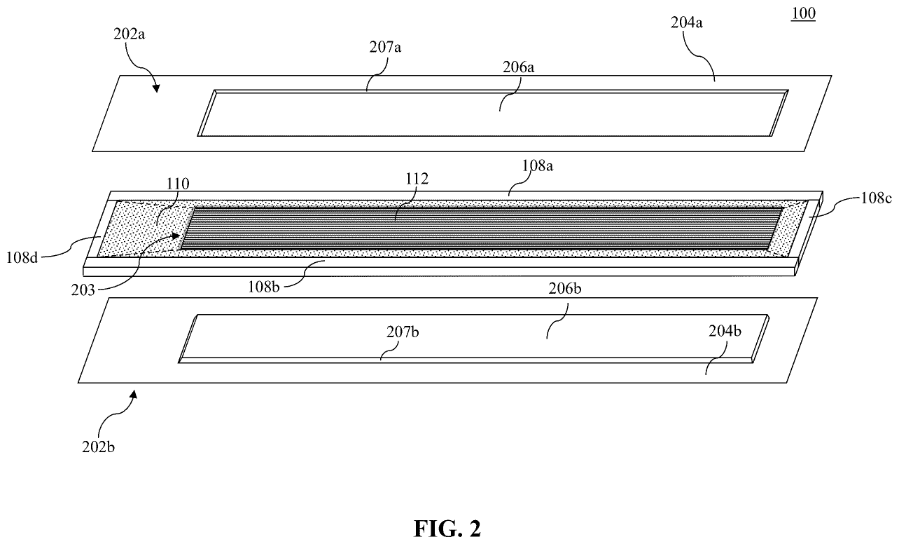

Door 100 can include two fiberglass doorskins (e.g., first and second doorskins 202a-b shown in FIG. 2) that define the front and rear sides of door 100. Doorskins 202a-b can be attached to frame 108. Doorskins 202a-b and frame 108 can collectively define an interior cavity 203 (shown in FIGS. 2-3).

In some embodiments, door 100 can include foam 110 to at least partially fill interior cavity 203 defined by frame 108 and the fiberglass doorskins 202a-b adjacent the rail and stiles of door 100. Foam 110 can provide structural support in addition to frame 108, ensuring a consistent door thickness along the entire height and width of the door. Additionally, foam 110 can provide sound attenuation.

In some embodiments, door 100 can also include a spacer 112 to at least partially fill interior cavity 203 of door 100 adjacent panel(s) 106. Spacer 112 can provide structural support, ensuring a consistent distance between adjacent panel portions 206a-b of doorskins 202a-b. Additionally, like foam 110, spacer 112 can provide sound attenuation.

FIG. 2 shows exploded view of door 100 according to some embodiments. As shown in FIG. 2, first doorskin 202a can include a first outer portion 204a and a first panel portion 206a recessed from first outer portion 204a. First doorskin 202a can also include a first sticking transition 207a between first outer portion 204a and first panel portion 206a. In some embodiments, first sticking transition 207a can be planar, for example, for a shaker-style design. In some embodiments, first sticking transition 207a can be non-planar; for example, first sticking transition 207a can include a concave or convex contour to provide varying aesthetics.

In some embodiments, second door skin 202b is substantially similar to first door skin 202a. For example, similar to first doorskin 202a, second doorskin 202b can include a second outer portion 204b and a second panel portion 206b recessed from the second outer portion 204b. As used herein, “recessed from” can refer to being recessed relative to a visible side of a doorskin of an assembled door 100. Second doorskin 202b can also include a second sticking transition 207b between second outer portion 204b and second panel portion 206b. In some embodiments, second sticking transition 207b can be planar. In some embodiments, second sticking transition 207b can be non-planar; for example, second sticking transition 207b can include a concave or convex contour to provide varying aesthetics.

As shown in FIG. 2, spacer 112 can be disposed between first and second panel portions 206a-b in interior cavity 203. Foam 110 can be disposed between first and second outer portions 204a-b of doorskins 202a and 202b, and between frame 108 and spacer 112. Accordingly, foam 110 and spacer 112 can be between first and second doorskins 202a-b.

During the manufacture of door 100, foam 110 can be disposed adjacent first and/or second outer portion 204a, 204b, between frame 108 and spacer 112. In some embodiments, disposing foam 110 can include injecting an expandable foam adjacent first and/or second outer portion 204a, 204b, between frame 108 and spacer 112, while one or both of first and second doorskins 202a-b are attached to frame 108. In some embodiments, disposing foam 110 can include disposing a solid foam segment (e.g., an expanded polystyrene (EPS) segment) adjacent first and/or second outer portion 204a, 204b, between frame 108 and spacer 112, while one of first and second doorskins 202a-b is attached to frame 108. In some embodiments, foam 110 can be a single, integral unit. In some embodiments, foam 110 can include a plurality of segments arranged within door 100.

FIG. 3 shows a cross-sectional view of door 100 according to some embodiments. As shown in FIG. 3, first doorskin 202a can be attached to a first side 302a of frame 108. Additionally, second doorskin 202b can be attached to a second side 302b of frame 108.

As shown in FIG. 3, first and second sticking transitions 207a, 207b can each define an angle θ relative to a plane 208 of first and second outer portions 204a, 204b, respectively. θ can be an angle between a sticking transition 207 and a plane 208 of an adjacent outer portion 204 (or interior stile/rail portion), for example, if the sticking transition 207 is planar. In any case, θ can be an angle formed by a line between points P₁, P₂, and P₃, shown in FIG. 3. For any angle θ, point P₁ is a point on a plane 208 of an outer portion 204 (or interior stile/rail portion), point P₂ is a point at which an adjacent sticking transition 207 begins to recede from the plane 208, and point P₃ is any point on the adjacent sticking transition 207. The line between points P₁, P₂, and P₃ extends at all points perpendicular to a lengthwise axis (e.g., axis L) of the nearest frame member (e.g., second frame member 108b). Any angle θ is an angle comprising empty space of a panel 106 recess, rather than solid portions of a stile 102 or rail 104.

In some embodiments, an angle θ can be greater than about 70 degrees. For example, in some embodiments, θ can be between about 72 degrees and about 90 degrees, between about 74 degrees and about 90 degrees, between about 76 degrees and about 90 degrees, between about 78 degrees and about 90 degrees, between about 80 degrees and about 90 degrees, between about 82 degrees and about 90 degrees, between about 84 degrees and about 90 degrees, between about 86 degrees and about 90 degrees, or between about 88 degrees and about 90 degrees. In some embodiments, a sticking transition 207 can be approximately perpendicular to a plane 208 of an outer portion 204. In some embodiments, an angle θ defined by first sticking transition 207a can be substantially the same as an angle θ defined by second sticking transition 207b. In some embodiments, an angle θ defined by first sticking transition 207a can be substantially different from an angle θ defined by second sticking transition 207b.

In some embodiments, first sticking transition 207a can define an angle θ within any one of the above ranges along an entire perimeter of first sticking transition 207a. Additionally or alternatively, in some embodiments, second sticking transition 2076 can define an angle θ within any one of the above ranges along an entire perimeter of second sticking transition 207b. In some embodiments, first sticking transition 207a can be approximately perpendicular to a plane 208 of first outer portion 204a along an entire perimeter of first sticking transition 207a. In some embodiments, second sticking transition 207b can be approximately perpendicular to a plane 208 of second outer portion 204b along an entire perimeter of second sticking transition 207b. The entire perimeters of first and second sticking transitions 207a-b are shown in FIG. 2.

First panel portion 206a can be recessed from first outer portion 204a by a first depth d_{R1}. First depth d_{R1} can be a distance between a plane 208 of first outer portion 204a and a point on first panel portion 206a, the distance being measured perpendicularly to the plane 208 of first outer portion 204a as shown in FIG. 3. In some embodiments, first depth d_{R1} can be between about 0.3 inches and about 0.75 inches, for example, between about 0.3 inches and about 0.7 inches, between about 0.3 inches and about 0.6 inches, between about 0.3 inches and about 0.5 inches, or about 0.4 inches. Second panel portion 206b can be recessed from second outer portion 204b by a second depth d_{R2}. Second depth d_{R2} can be a distance between a plane 208 of second outer portion 204b and a point on second panel portion 206b, the distance being measured perpendicularly to the plane 208 of second outer portion 204b as shown in FIG. 3. In some embodiments, second depth d_{R2} can be between about 0.3 inches and about 0.75 inches, for example, between about 0.3 inches and about 0.7 inches, between about 0.3 inches and about 0.6 inches, between about 0.3 inches and about 0.5 inches, or about 0.4 inches. In some embodiments, first depth d_{R1} and second depth d_{R2} can be substantially the same. In some embodiments, first depth d_{R1} and second depth d_{R2} can be substantially different. In some embodiments, door 100 can include a panel portion 206 recessed from an outer portion 204 on only one side 304 of door 100. That is, either first depth d_{R1} or second depth d_{R2} can be 0.

In some embodiments, panel 106 can have a panel thickness t_{P} between about 0.375 inches and about 1.5 inches. For example, in some embodiments, panel thickness t_{P} can be between about 0.375 inches and about 1.25 inches, between about 0.375 inches and about 1 inch, between about 0.375 inches and about 0.75 inches, between about 0.4 inches and about 0.6 inches, or about 0.5 inches.

In some embodiments, first stile 102a and/or second stile 102b can have a stile thickness t_{S} between about 0.75 inches and about 2.5 inches. For example, in some embodiments, stile thickness t_{S} can be between about 0.75 inches and about 2 inches, between about 0.75 inches and about 1.75 inches, between about 1 inch and about 1.5 inches, between about 1.2 inches and about 1.5 inches, or about 1.375 inches.

In some embodiments, first frame member 108a and/or second frame member 108b can have a frame width w_{F} between about 0.75 inches and about 3 inches. For example, in some embodiments, frame width w_{F} can be between about 0.75 inches and about 2.5 inches, between about 0.75 inches and about 2 inches, between about 0.75 inches and about 1.5 inches, between about 0.9 inches and about 1.3 inches, or about 1.1 inches.

Collectively, first and second outer portions 204a-b and first and second sticking transitions 207a-b can at least partially make up stiles 102 and rails 104 of door 100, as shown in FIG. 2. For example, first and second outer portions 204a-b and first and second sticking transitions 207a-b can form outer layers of stiles 102 and rails 104. Similarly, first and second panel portions 206a-b can at least partially make up panel 106. For example, first and second panel portions 206a-b can form outer layers of panel 106. Collectively, first outer portion 204a, first sticking transition 207a, and first panel portion 206a can form a first side 304a of door 100. Similarly, second outer portion 204b, second sticking transition 207b, and second panel portion 206b can form a second side 304b of door 100.

As shown in FIG. 3, spacer 112 can be disposed between first panel portion 206a and second panel portion 206b. Spacer 112 can fill a volume defined by the first and second panel portions 206a-b, as demarcated by lines A and B. Lines A and B run through points of transition between first and second outer portions 204a-b and panel portions 206a-b, and mark the boundaries between first and second stiles 102a, 102b and panel 106. In some embodiments, spacer 112 can fill substantially the entire volume defined by first and second panel portions 206a-b. In some embodiments, spacer 112 can contact first and second doorskins 202a-b. In some embodiments, spacer 112 can contact foam 110.

In some embodiments, spacer 112 can comprise cardboard. For example, in some embodiments, spacer 112 can comprise corrugated cardboard. In some embodiments, spacer 112 can comprise wood, for example, a wood composite. In some embodiments, spacer 112 can comprise oriented strand board (OSB). In some embodiments, spacer 112 can comprise foam. For example, in some embodiments, spacer 112 can comprise any of the materials foam 110 can comprise. In some embodiments, spacer 112 can comprise the same material as foam 110. In some embodiments, foam 110 and spacer 112 can be a continuous foam structure formed, for example, by injecting an expandable foam in between first and second doorskins 202a-b.

As shown in FIG. 3, foam 110 can be disposed between first and second outer portions 204a-b. In some embodiments, foam 110 can contact first and second doorskins 202a-b. Additionally, in some embodiments, foam 110 can contact frame 108 and spacer 112. In some embodiments, foam 110 can fill a volume defined by first and second outer portions 204a-b, first and second sticking transitions 207a-b, and frame 108, as demarcated by lines A and B. In some embodiments, foam 110 can fill substantially the entire volume defined by first and second outer portions 204a-b, first and second sticking transitions 207a-b, and frame 108.

In some embodiments, foam 110 can comprise expanded polystyrene (EPS). In some embodiments, foam 110 can comprise polyethylene (PE). In some embodiments, foam 110 can comprise polypropylene (PP). In some embodiments, cardboard (e.g., single or multi-wall corrugated cardboard) and/or a wood composite (e.g., OSB and/or MDF) can be used in place of foam 110.

While FIG. 3 shows a lateral cross-section transecting first and second stiles 102a-b, the disclosure above can apply to a longitudinal cross-section transecting first and second rails 104a-b. The stile and frame dimensions described with respect to FIG. 3 can apply to the rails and frame members shown in such a longitudinal cross-section. However, as is shown in FIG. 1, the distance between fourth frame member 108d and spacer 112 can be greater than the distance between first or second frame member 108a, 108b and spacer 112. Accordingly, foam 110 can at least partially fill a larger volume at the bottom of door 100 than at its sides, which are depicted in FIG. 3.

So far, door 100 has been shown as including a single panel 106. Accordingly, first and second doorskins 202a, 202b have each been shown as including a single first or second panel portion 206a, 206b, respectively. However, in some embodiments, first doorskin 202a can include a plurality of first panel portions 206a recessed from first outer portion 204a, with other raised portion(s) on first doorskin 202a dividing the plurality of first panel portions 206a. Each of the plurality of first panel portions 206a can be surrounded by a first sticking transition 207a. Likewise, second doorskins 202b can include a plurality of second panel portions 206b recessed from second outer portion 204b, with other raised portion(s) on second doorskin 202b dividing the plurality of second panel portions 206b. Each of the plurality of second panel portions 206b can be surrounded by a second sticking transition 207b.

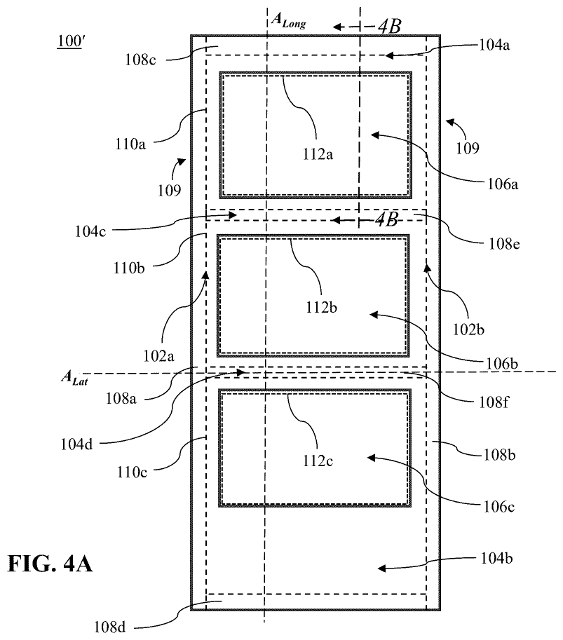

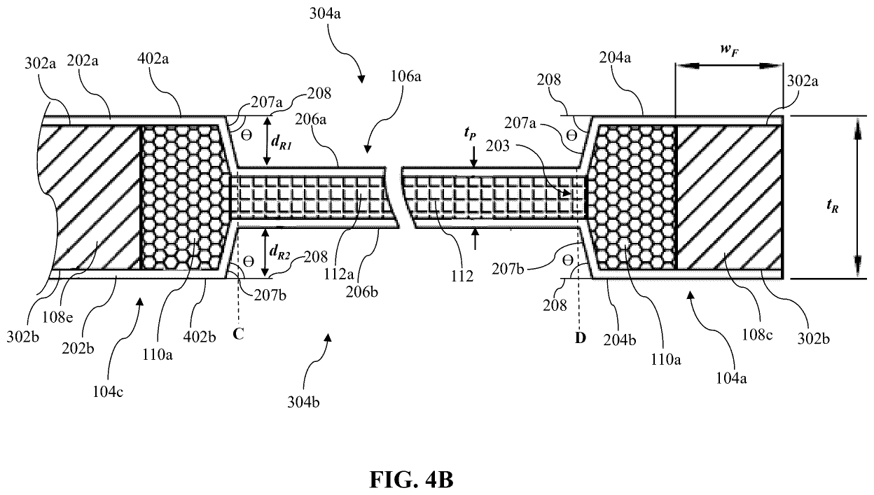

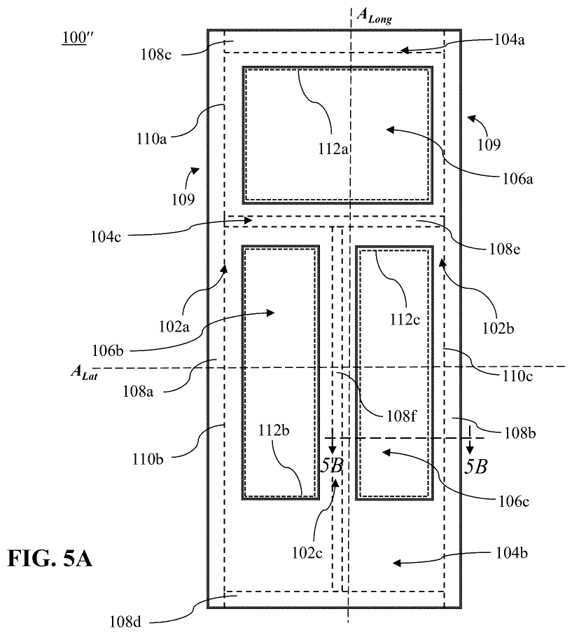

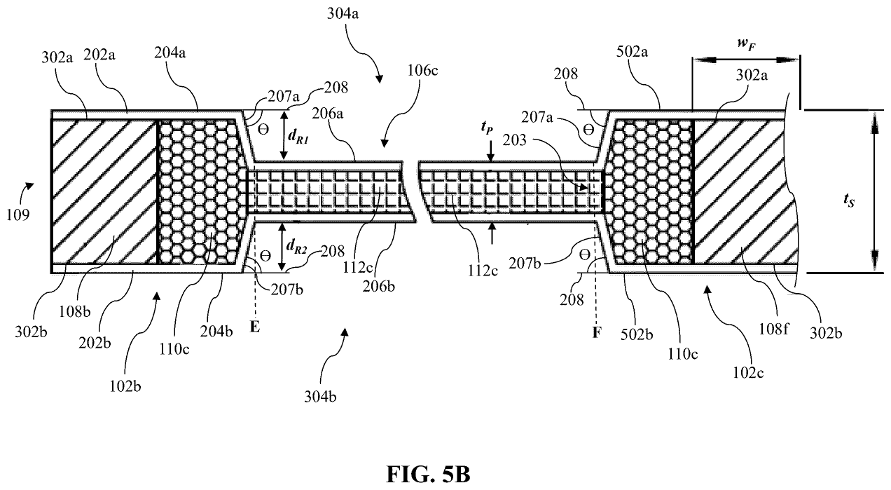

In such embodiments, when doorskins 202a-b, frame 108, foam 110, and spacer 112 are assembled, the plurality of first panel portions 206a can be aligned with the plurality of second panel portions 206b. Resulting doors 100′ and 100″ that include a plurality of panels 106 are shown in FIGS. 4-5. The other raised portions on first and second doorskins 202a-b can help define additional stile(s) 102 and/or rail(s) 104 that pass through interior regions of doors 100′ and 100″, as shown in FIGS. 4-5.

FIG. 4A shows a door 100′ according to some embodiments. Door 100′ can include a plurality of panels 106. For example, door 100′ can include a first panel 106a, a second panel 106b, and a third panel 106c. In some embodiments, first, second, and third panels 106a-c can share a single longitudinal axis (e.g., A_{Long}) of door 100′ and can be separated along the longitudinal axis. In such embodiments, the entireties of two panels 106 separated along a longitudinal axis of door 100′ are positioned on opposing sides of a single latitudinal axis (e.g., A_{Lat}) of door 100′, as is shown in FIG. 4A.

While FIG. 4A shows door 100′ having three panels 106, door 100′ can include any number of panels 106 so arranged.

As shown in FIG. 4A, door 100′ can include additional rails 104 between panels 106. For example, door 100′ can include third rail 104c and fourth rail 104d.

In some embodiments, frame 108 of door 100′ can include additional frame members. For example, frame 108 of door 100′ can include fifth frame member 108e and sixth frame member 108f extending horizontally between first frame member 108a and second frame member 108b. Fifth and sixth frame members 108e-f can be secured to first and second frame members 108a-b. However, fifth and/or sixth frame members 108e-f are optional, and door 100′ can include just an exterior frame 108 comprising first, second, third, and fourth frame members 108a-d.

In embodiments in which door 100′ includes fifth and/or sixth frame members 108e-f, foam 110 can be divided into multiple sections. For example, foam 110 can comprise a first foam section 110a, a second foam section 110b, and a third foam section 110c. Similar to foam 110 of door 100, foam of each of first, second, and third foam sections 110a-c can be disposed between first and second doorskins 202a-b, and between member(s) of frame 108 and a spacer 112.

As shown in FIG. 4A, door 100′ can include a plurality of spacers 112. For example, door 100′ can include a first spacer 112a, a second spacer 112b, and a third spacer 112c. Similar to spacer 112 of door 100, each of first, second, and third spacers 112a-c can be disposed between a first panel portion 206a of first doorskin 202a and a second panel portion 206b of second doorskin 202b.

FIG. 4B shows a cross-sectional view of a portion of door 100′, according to some embodiments. In some embodiments, first doorskin 202a can be attached to fifth frame member 108c on first side 302a of frame 108, and second doorskin 202b can be attached to fifth frame member 108e on second side 302b of frame 108.

As shown in FIG. 4B, first doorskin 202a can include a first interior rail portion 402a, wherein a first panel portion 206a of first doorskin 202a is recessed from first interior rail portion 402a. Similarly, second doorskin 202b can include a second interior rail portion 402b, wherein a second panel portion 206b of second doorskin 202b is recessed from second interior rail portion 402b.

The features of first and second sticking transitions 207a, 207b and an angle θ shown in FIG. 4B can be substantially the same as those described with respect to FIG. 3, except that an angle θ shown in FIG. 4B can be measured relative to a plane 208 of an interior rail portion 402 in addition to that of an outer portion 204.

The features of depths d_{R1} and d_{R2} can be substantially the same as those described with respect to FIG. 3, except that depths d_{R1} and d_{R2} shown in FIG. 4B can be measured relative to a plane 208 of an interior rail portion 402 in addition to that of an outer portion 204.

The features of t_{P} can be substantially the same as those described with respect to FIG. 3.

In some embodiments, first rail 104a and/or third rail 104c can have a rail thickness t_{R} substantially the same as stile thickness t_{S} described above with respect to FIG. 3.

In some embodiments, third frame member 108c and/or fifth frame member 108e can have a frame width w_{F} substantially the same as frame width w_{F} described with respect to FIG. 3.

Collectively, first and second interior rail portions 402a-b and portions of first and second sticking transitions 207a-b can at least partially make up third rail 104c of door 100′. For example, first and second interior rail portions 402a-b and portions of first and second sticking transitions 207a-b can form outer layers of third rail 104c, shown in FIG. 4B.

As shown in FIG. 4B, first spacer 112a can be disposed between a first panel portion 206a and a second panel portion 206b of first and second doorskins 202a, 202b, respectively. First spacer 112a can fill a volume defined by the first and second panel portions 206a-b of first panel 106a, as demarcated by lines C and D. Lines C and D run through points of transition between first and second interior rail portions 402a-b and panel portions 206a-b—and between first and second outer portions 204a-b and panel portions 206a-b—and mark the boundaries between first and third rails 104a, 104c and first panel 106a. In some embodiments, first spacer 112a can fill substantially the entire volume defined by first and second panel portions 206a-b of first panel 106a. In some embodiments, first spacer 112a can contact first and second doorskins 202a-b. First spacer 112a can comprise any of the materials discussed above for spacer 112.

As shown in FIG. 4B, foam of first foam section 110a can be disposed between first and second interior rail portions 402a-b. In some embodiments, first foam section 110a can contact first and second doorskins 202a-b. Additionally, in some embodiments, first foam section 110a can contact frame 108 and first spacer 112a. In some embodiments, first foam section 110a can fill a volume defined by first and second outer portions 204a-b, first and second interior rail portions 402a-b shown in FIG. 4B, first and second sticking transitions 207a-b, and frame 108, as demarcated by lines C and D. In some embodiments, foam section 110a can fill substantially the entire volume defined by first and second outer portions 204a-b, first and second interior rail portions 402a-b shown in FIG. 4B, first and second sticking transitions 207a-b, and frame 108. First foam section 110a can comprise any of the materials discussed above for foam 110.

First doorskin 202a can include a plurality of first interior rail portions 402a and a plurality of first sticking transitions 207a to form the plurality of rails 104c-d and panels 106a-c shown in FIG. 4A. Likewise, second doorskin 202b can include a plurality of second interior rail portions 402b and a plurality of second sticking transitions 207b to form the plurality of rails 104c-d and panels 106a-c shown in FIG. 4A.

As noted, frame member 108e can be optional. In embodiments that do not include frame member 108e, foam 110 can extend between first spacer 112a and second spacer 112b. In such embodiments, foam 110 can be continuous (i.e., no frame member 108e-f separates foam 110 into discontinuous sections 110a-c). Continuous foam 110 can still include a plurality of segments, as discussed with respect to FIG. 2, such that “continuous” in this context can simply refer to not being separated by another component of door 100′.

While FIG. 4B shows a cross-sectional view that depicts only one panel (first panel 106a), spacer (first spacer 112a), and foam section (first foam section 110a), it should be understood that the disclosure related to FIG. 4B can apply to any combination of a panel 106a, 106b, or 106c, spacer 112a, 112b, or 112c, foam section 110a, 110b, or 110c, and pair of frame members 108c, 108e, frame members 108e, 108f, or frame members 108d, 108f of door 100′.

FIG. 5A shows a door 100″ according to some embodiments. Door 100″ can include a plurality of panels 106. For example, like door 100′, door 100″ can include a first panel 106a, a second panel 106b, and a third panel 106c. However, unlike door 100′, first, second, and third panels 106a-c do not all share a single longitudinal axis of door 100″. Instead, door 100″ can include a plurality of panels 106 (e.g., second and third panels 106b-c) that share a single latitudinal axis (e.g., A_{Lat}) of door 100″ and can be separated along the latitudinal axis. In such embodiments, the entireties of two panels 106 separated along a latitudinal axis of door 100″ are positioned on opposing sides of a single longitudinal axis (e.g., A_{Long}) of door 100′, as is shown in FIG. 5A.

While FIG. 5A shows door 100″ having three panels 106, door 100″ can include any number of panels 106 arranged in various combinations. For example, door 100″ can include one, two, three, or four panels 106 sharing a single latitudinal axis and zero, one, two, three, or four panels 106 sharing a single longitudinal axis.

As shown in FIG. 5A, door 100″ can include additional stiles 102 between panels 106, as compared to door 100 or door 100′. For example, door 100″ can include third stile 102c. In some embodiments of door 100″, sixth frame member 108f can extend vertically between fourth frame member 108d and fifth frame member 108e. In some embodiments, sixth frame member 108f can be secured to fourth and fifth frame members 108d-e. However, fifth frame member 108e and/or sixth frame member 108f are optional, and door 100″ can include just an exterior frame 108 comprising first, second, third, and fourth frame members 108a-d, or a frame 108 comprising just first, second, third, fourth, and fifth frame members 108a-c.

The features of first, second, and third foam sections 110a-c and first, second, and third spacers 112a-c can be substantially the same as those described above with respect to FIGS. 4A-B. Similar to foam sections 110a-c of door 100′, foam of each of first, second, and third foam sections 110a-c of door 100″ can be disposed between first and second doorskins 202a-b, and between member(s) of frame 108 and a spacer 112. Similar to spacers 112a-c of door 100′, each of first, second, and third spacers 112a-c of door 100″ can be disposed between a first panel portion 206a of first doorskin 202a and a second panel portion 206b of second doorskin 202b.

FIG. 5B shows a cross-sectional view of a portion of door 100″, according to some embodiments. In some embodiments, first doorskin 202a can be attached to sixth frame member 108f on first side 302a of frame 108, and second doorskin 202b can be attached to sixth frame member 108f on second side 302b of frame 108.

As shown in FIG. 5B, first doorskin 202a can include a first interior stile portion 502a, wherein a first panel portion 206a of first doorskin 202a is recessed from first interior stile portion 502a. Similarly, second doorskin 202b can include a second interior stile portion 502b, wherein a second panel portion 206b of second doorskin 202b is recessed from second interior stile portion 502b.

The features of first and second sticking transitions 207a, 207b and an angle θ shown in FIG. 5B can be substantially the same as those described with respect to FIG. 3, except that an angle θ shown in FIG. 5B can be measured relative to a plane 208 of an interior stile portion 502 in addition to that of an outer portion 204.

The features of depths d_{R1} and d_{R2} can be substantially the same as those described with respect to FIG. 3, except that depths d_{R1} and d_{R2} shown in FIG. 5B can be measured relative to a plane 208 of an interior stile portion 502 in addition to that of an outer portion 204.

The features of t_{P} can be substantially the same as those described with respect to FIG. 3.

In some embodiments, third stile 102c can have a stile thickness t_{S} substantially the same as stile thickness t_{S} described above with respect to FIG. 3.

In some embodiments, sixth frame member 108f can have a frame width w_{F} substantially the same as frame width w_{F} described with respect to FIG. 3.

Collectively, first and second interior stile portions 502a-b and portions of first and second sticking transitions 207a-b can at least partially make up third stile 102c of door 100″. For example, first and second interior stile portions 502a-b and portions of first and second sticking transitions 207a-b can form outer layers of third stile 102c, shown in FIG. 5B.

As shown in FIG. 5B, third spacer 112c can be disposed between a first panel portion 206a and a second panel portion 206b of first and second doorskins 202a, 202b, respectively. Third spacer 112c can fill a volume defined by the first and second panel portions 206a-b of third panel 106c, as demarcated by lines E and F. Lines E and F run through points of transition between first and second outer portions 204a-b and panel portions 206a-b—and between first and second interior stile portions 502a-b and panel portions 206a-b—and mark the boundaries between second and third stiles 102b, 102c and third panel 106c. In some embodiments, third spacer 112c can fill substantially the entire volume defined by first and second panel portions 206a-b of third panel 106c. In some embodiments, third spacer 112c can contact first and second doorskins 202a-b. Third spacer 112c can comprise any of the materials discussed above for spacer 112.

As shown in FIG. 5B, foam of third foam section 110c can be disposed between first and second interior stile portions 502a-b. In some embodiments, third foam section 110c can contact first and second doorskins 202a-b. Additionally, in some embodiments, third foam section 110c can contact frame 108 and third spacer 112c. In some embodiments, third foam section 110c can fill a volume defined by first and second outer portions 204a-b, first and second interior stile portions 502a-b shown in FIG. 5B, first and second sticking transitions 207a-b, and frame 108, as demarcated by lines E and F. In some embodiments, third foam section 110c can fill substantially the entire volume defined by first and second outer portions 204a-b, first and second interior stile portions 502a-b shown in FIG. 5B, first and second sticking transitions 207a-b, and frame 108. Third foam section 110c can comprise any of the materials discussed above for foam 110.

In some embodiments, first doorskin 202a can include a plurality of first interior stile portions 502a and a plurality of first sticking transitions 207a to form a plurality of interior stiles (e.g., like third stile 102c) and panels 106 that share a latitudinal axis (e.g., A_{Lat}) of door 100″. Likewise, second doorskin 202b can include a plurality of second interior stile portions 502b and a plurality of second sticking transitions 207b to form the plurality of interior stiles (e.g., like third stile 102c) and panels 106 that share a latitudinal axis of door 100″.

As noted, frame member 108f can be optional. In embodiments that do not include frame member 108f, foam 110 can extend between second spacer 112b and third spacer 112c. In such embodiments, second and third foam sections 110b-c can be continuous (i.e., no frame member 108f separates second and third foam sections 110b-c into discontinuous sections 110b-c). Continuous second and third foam sections 110b-c can still include a plurality of segments, as discussed with respect to FIG. 2, such that “continuous” in this context can simply refer to not being separated by another component of door 100″.

While FIG. 5B shows a cross-sectional view that depicts only one panel (third panel 106c), spacer (third spacer 112c), and foam section (third foam section 110c), it should be understood that the disclosure related to FIG. 5B can also apply to second panel 106b, second spacer 112b, second foam section 110b, and first and sixth frame members 108a, 108f.

While FIGS. 1, 4A, and 5A show various panel configurations on doors 100, 100′, and 100″, it should be understood that an interior door according to the present disclosure can include any panel configuration. For example, an interior door according to the present disclosure can include any number of panels 106 (e.g., 1, 2, 3, 4, 5, etc.) that share a single longitudinal axis and/or any number of panels 106 (e.g., 1, 2, 3, 4, 5, etc.) that share a single latitudinal axis. In any case, the disclosure contained herein related to panel depths, angles defined by sticking transitions between stiles/rails and panels, and the placement of interior components such as foam and spacer(s) can still apply for a given panel and its surrounding regions.

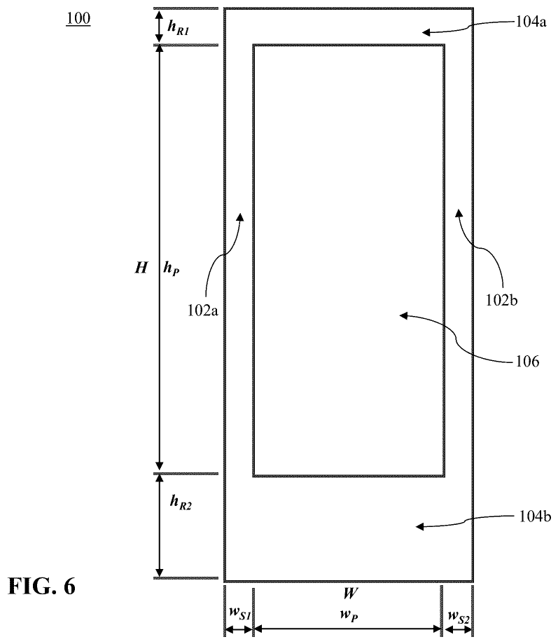

FIG. 6 shows example dimensions of door 100, according to some embodiments. As shown in FIG. 6, first stile 102a can have a width w_{S1} and second stile 102b can have a width w_{S2}. In some embodiments, widths w_{S1} and w_{S2} can be substantially the same. In some embodiments, widths w_{S1} and w_{S2} can be substantially different. First rail 104a can have a height h_{R1} and second rail 104b can have a height h_{R2}.

Panel 106 can have a width w_{P} and a height h_{P}. Door 100 can have a total width W and a total height H.

The below table shows exemplary combinations of values for each of these dimensions. All dimensions are in inches. It should be understood that a value for a listed dimensions can be within a range expressed as the range between any two values listed for that dimension. For example, width W of door 100 can be between about 16.5 inches and about 36.5 inches, and/or between about 22.5 inches and about 32.5 inches. As another example, width w_{S1} and/or w_{S2} can be between about 4.0 and about 6.0 inches. Additionally, when only a single value is listed for a dimension (e.g., height h_{R2}), a value for that dimension can be in a range that is ±about 15% of the listed value.

TABLE 1
Example Dimensions of Door 100

| W | H | w_{P} | w_{S1}, w_{S2} | h_{P} | h_{R1} | h_{R2} |
|---|---|---|---|---|---|---|
| 16.5 | 84.5 | 6.5 | 5.0 | 64.5 | 6.5 | 13.5 |
| 18.5 | 84.5 | 9.5 | 4.5 | 64.5 | 6.5 | 13.5 |
| 20.5 | 84.5 | 9.5 | 5.5 | 64.5 | 6.5 | 13.5 |
| 22.5 | 84.5 | 14.5 | 4.0 | 64.5 | 6.5 | 13.5 |
| 24.5 | 84.5 | 14.5 | 5.0 | 64.5 | 6.5 | 13.5 |
| 26.5 | 84.5 | 18.5 | 4.0 | 64.5 | 6.5 | 13.5 |
| 28.5 | 84.5 | 18.5 | 5.0 | 64.5 | 6.5 | 13.5 |
| 30.5 | 84.5 | 20.5 | 5.0 | 64.5 | 6.5 | 13.5 |
| 32.5 | 84.5 | 22.5 | 5.0 | 64.5 | 6.5 | 13.5 |
| 34.5 | 84.5 | 24.5 | 5.0 | 64.5 | 6.5 | 13.5 |
| 36.5 | 84.5 | 24.5 | 6.0 | 64.5 | 6.5 | 13.5 |

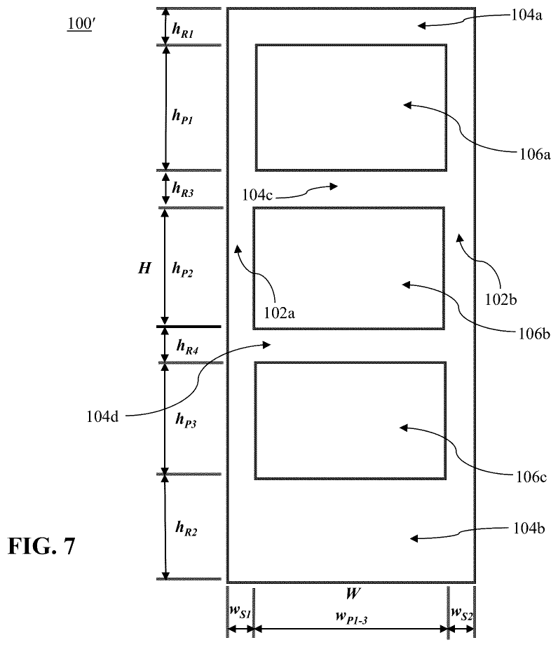

FIG. 7 shows example dimensions of door 100′, according to some embodiments. As shown in FIG. 7, first stile 102a can have a width w_{S1} and second stile 102b can have a width w_{S2}. In some embodiments, widths w_{S1} and w_{S2} can be substantially the same. In some embodiments, widths w_{S1} and w_{S2} can be substantially different. First rail 104a can have a height h_{R1}, second rail 104b can have a height h_{R2}, third rail 104c can have a height h_{R3}, and fourth rail 104d can have a height h_{R4}. In some embodiments, heights h_{R3} and h_{R4} can be substantially the same. In some embodiments, heights h_{R3} and h_{R4} can be substantially different.

First panel 106a can have a width w_{P1}, second panel 106b can have a width w_{P2}, and third panel 106c can have a width w_{P3}. In some embodiments, widths w_{P1}, w_{P2}, and/or w_{P3} can be substantially the same. In some embodiments, widths w_{P1}, w_{P2}, and/or w_{P3} can be substantially different. First panel 106a can have a height h_{P1}, second panel 106b can have a height h_{P2}, and third panel 106c can have a height h_{P3}. In some embodiments, heights h_{P1}, h_{P2}, and/or h_{P3} can be substantially the same. In some embodiments, heights h_{P1}, h_{P2}, and/or h_{P3} can be substantially different. Door 100′ can have a total width W and a total height H.

The below table shows exemplary combinations of values for each of these dimensions. All dimensions are in inches. It should be understood that a value for a listed dimensions can be within a range expressed as the range between any two values listed for that dimension. For example, width w_{P1} of first panel 106a can be between about 6.5 inches and about 24.5 inches, and/or between about 14.5 inches and about 18.5 inches. As another example, width w_{S1} and/or w_{S2} can be between about 4.0 and about 6.0 inches. Additionally, when only a single value is listed for a dimension (e.g., height h_{R3} and/or h_{R4}), a value for that dimension can be in a range that is ±about 15% of the listed value.

TABLE 2
Example Dimensions of Door 100′

| W | H | w_{P1}, w_{P2}, w_{P3} | w_{S1}, w_{S2} | h_{P1}, h_{P2}, h_{P3} | h_{R1} | h_{R2} | h_{R3}, h_{R4} |
|---|---|---|---|---|---|---|---|
| 16.5 | 84.5 | 6.5 | 5.0 | 18.8 | 6.5 | 13.5 | 4.05 |
| 18.5 | 84.5 | 9.5 | 4.5 | 18.8 | 6.5 | 13.5 | 4.05 |
| 20.5 | 84.5 | 9.5 | 5.5 | 18.8 | 6.5 | 13.5 | 4.05 |
| 22.5 | 84.5 | 14.5 | 4.0 | 18.8 | 6.5 | 13.5 | 4.05 |
| 24.5 | 84.5 | 14.5 | 5.0 | 18.8 | 6.5 | 13.5 | 4.05 |
| 26.5 | 84.5 | 18.5 | 4.0 | 18.8 | 6.5 | 13.5 | 4.05 |
| 28.5 | 84.5 | 18.5 | 5.0 | 18.8 | 6.5 | 13.5 | 4.05 |
| 30.5 | 84.5 | 20.5 | 5.0 | 18.8 | 6.5 | 13.5 | 4.05 |
| 32.5 | 84.5 | 22.5 | 5.0 | 18.8 | 6.5 | 13.5 | 4.05 |
| 34.5 | 84.5 | 24.5 | 5.0 | 18.8 | 6.5 | 13.5 | 4.05 |
| 36.5 | 84.5 | 24.5 | 6.0 | 18.8 | 6.5 | 13.5 | 4.05 |

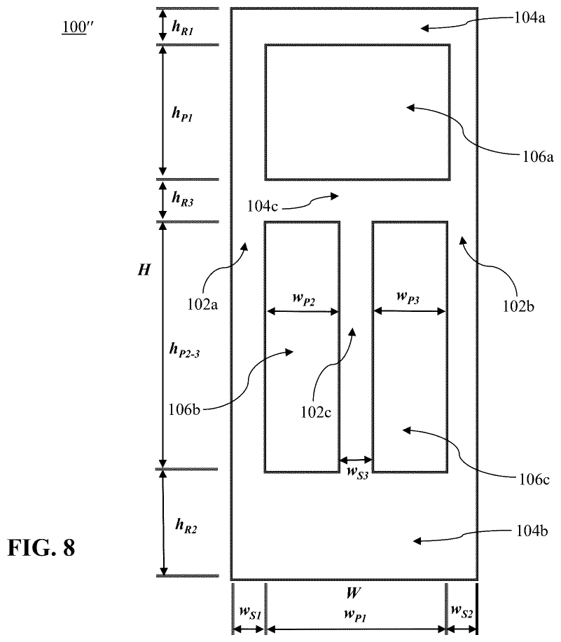

FIG. 8 shows example dimensions of door 100″, according to some embodiments. As shown in FIG. 8, first stile 102a can have a width w_{S1} and second stile 102b can have a width w_{S2}. In some embodiments, widths w_{S1} and w_{S2} can be substantially the same. In some embodiments, widths w_{S1} and w_{S2} can be substantially different. Third stile 102c can have a width w_{S3}. First rail 104a can have a height h_{R1}, second rail 104b can have a height h_{R2}, and third rail 104c can have a height h_{R3}.

First panel 106a can have a width w_{P1}, second panel 106b can have a width w_{P2}, and third panel 106c can have a width w_{P3}. In some embodiments, widths w_{P2} and w_{P3} can be substantially the same. In some embodiments, widths w_{P2} and w_{P3} can be substantially different. First panel 106a can have a height h_{P1}, second panel 106b can have a height h_{P2}, and third panel 106c can have a height h_{P3}. In some embodiments, heights h_{P2} and h_{P3} can be substantially the same. In some embodiments, heights h_{P2} and h_{P3} can be substantially different. Door 100″ can have a total width W and a total height H.

The below table shows exemplary combinations of values for each of these dimensions. All dimensions are in inches. It should be understood that a value for a listed dimensions can be within a range expressed as the range between any two values listed for that dimension. For example, width w_{P2} and/or w_{P3} can be between about 5.3 inches and about 10.3 inches, and/or between about 6.5 inches and about 9.5 inches. As another example, width w_{S1} and/or w_{S2} can be between about 4.0 and about 6.0 inches. Additionally, when only a single value is listed for a dimension (e.g., w_{S3}), a value for that dimension can be in a range that is ±about 15% of the listed value.

TABLE 3
Example Dimensions of Door 100″

| W | H | w_{P1} | w_{P2}, w_{P3} | w_{S1}, w_{S2} | w_{S3} | h_{P1} | h_{P2}, h_{P3} | h_{R1} | h_{R2} | h_{R3} |
|---|---|---|---|---|---|---|---|---|---|---|
| 16.5 | 84.5 | 6.5 | 6.5* | 5.0 | N/A | 18.0 | 42.5 | 6.5 | 13.5 | 4.0 |
| 18.5 | 84.5 | 9.5 | 9.5* | 4.5 | N/A | 18.0 | 42.5 | 6.5 | 13.5 | 4.0 |
| 20.5 | 84.5 | 9.5 | 9.5* | 5.5 | N/A | 18.0 | 42.5 | 6.5 | 13.5 | 4.0 |
| 22.5 | 84.5 | 14.5 | 5.3 | 4.0 | 3.7 | 18.0 | 42.5 | 6.5 | 13.5 | 4.0 |
| 24.5 | 84.5 | 14.5 | 5.3 | 5.0 | 3.7 | 18.0 | 42.5 | 6.5 | 13.5 | 4.0 |
| 26.5 | 84.5 | 18.5 | 7.3 | 4.0 | 3.7 | 18.0 | 42.5 | 6.5 | 13.5 | 4.0 |
| 28.5 | 84.5 | 18.5 | 7.3 | 5.0 | 3.7 | 18.0 | 42.5 | 6.5 | 13.5 | 4.0 |
| 30.5 | 84.5 | 20.5 | 8.3 | 5.0 | 3.7 | 18.0 | 42.5 | 6.5 | 13.5 | 4.0 |
| 32.5 | 84.5 | 22.5 | 9.3 | 5.0 | 3.7 | 18.0 | 42.5 | 6.5 | 13.5 | 4.0 |
| 34.5 | 84.5 | 24.5 | 10.3 | 5.0 | 3.7 | 18.0 | 42.5 | 6.5 | 13.5 | 4.0 |
| 36.5 | 84.5 | 24.5 | 10.3 | 6.0 | 3.7 | 18.0 | 42.5 | 6.5 | 13.5 | 4.0 |

(*Includes only single bottom panel 106b or 106c)

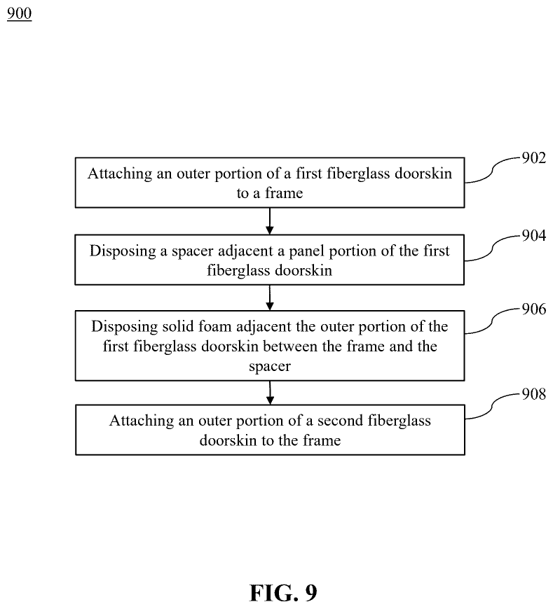

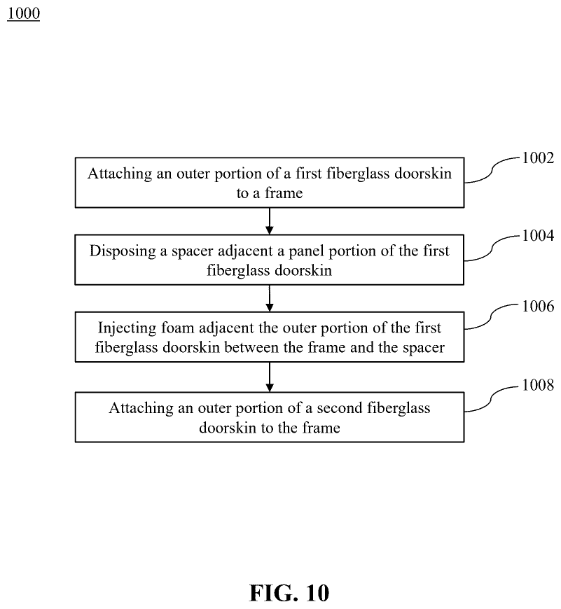

FIGS. 9-10 show methods 900 and 1000 of manufacturing an interior door (e.g., door 100, 100′, or 100″) using fiberglass. In some embodiments, the interior door can be a shaker door.

In some embodiments, methods 900 and 100 can each include the following steps: (1) attaching an outer portion of a first fiberglass doorskin to a frame; (2) disposing a spacer adjacent a panel portion of the first fiberglass doorskin; (3) disposing foam adjacent the outer portion of the first fiberglass doorskin between the frame and the spacer; and (4) attaching an outer portion of a second fiberglass doorskin to the frame.

In some embodiments, step 1 includes step 902 or 1002 as described below. In some embodiments, step 2 includes step 904 or 1004 as described below. In some embodiments, step 3 includes step 906 or step 1006 described below. In some embodiments, step 4 includes step 908 or 1008 as described below.

Unless stated otherwise, the steps of method 900 or method 1000 need not be performed in the order set forth herein. Additionally, unless otherwise specified, the steps of method 900 or method 1000 need not be performed sequentially. The steps can be performed in a different order or simultaneously. As one example, step 904 need not be performed before step 906, but can be performed simultaneously with or after step 906. As another example, step 1006 need not be performed before step 1008, but can be performed after step 1008. As another example, steps 904 and/or 906 and steps 1004 and/or 1006 need not be performed before steps 902 and 1002, respectively, but can be performed before steps 902 and 1002. Further, method 900 or method 1000 need not comprise all the steps illustrated.

Steps 902 and 1002 can include attaching an outer portion (e.g., first outer portion 204a) of a first fiberglass doorskin (e.g., first doorskin 202a) to a frame (e.g., frame 108). In some embodiments, the outer portion can be attached to the frame using an adhesive, such as a glue. Additionally or alternatively, in some embodiments, the outer portion can be attached to the frame using screws, nails, tacks, bolts, etc.

Steps 904 and 1004 can include disposing a spacer (e.g., spacer 112, first spacer 112a, second spacer 112b, or third spacer 112c) adjacent a panel portion (e.g., a first panel portion 206a) of the first fiberglass doorskin. The spacer can be disposed on an interior-facing side (i.e., a side that faces toward internal components of an assembled door) of the first fiberglass doorskin. In some embodiments, the spacer can contact the panel portion. In some embodiments, steps 904 and 1004 can include aligning the spacer with the panel portion on the interior-facing side of the first fiberglass doorskin, such that one or more boundaries of the spacer are within a certain tolerance distance (e.g., 0.5 inches) from one or more boundaries of the panel portion. Additionally or alternatively, steps 904 and 1004 can include aligning the spacer with the panel portion on the interior side of the first fiberglass doorskin, such that a center of the spacer is within a certain tolerance distance (e.g., 0.5 inches) from a center of the panel portion. In some embodiments, the spacer can be attached to the panel portion, for example, using a glue.

Step 906 can include disposing solid foam (e.g., one or more solid foam segments) adjacent the outer portion of the first fiberglass doorskin between the frame and the spacer. In some embodiments, the solid foam being disposed can comprise expanded polystyrene (EPS). In some embodiments, disposing solid foam can include fitting multiple segments of solid foam together to form a foam structure that surrounds a perimeter of a panel 106.

As used herein, “disposing component X between component Y and component Z” should not be interpreted to strictly mean disposing component X between component Y and component Z in a single step. Rather, “disposing component X between component Y and component Z” can refer to disposing, in any order, component Y at a location, component X at a second location, and component Z at a third location such that component X is between component Y and component Z. Accordingly, in some embodiments, step 906 can be performed before or after step 904, which includes disposing the spacer. The solid foam can be disposed adjacent the outer portion of the first fiberglass doorskin, and the spacer can then be disposed adjacent the panel portion such that the solid foam is between the frame and the spacer. In some embodiments, steps 902-906 can be performed in any order so long as the solid foam is ultimately between the frame and the spacer.

Like the spacer, the solid foam can be disposed on an interior-facing side of the first fiberglass doorskin. In some embodiments, the solid foam can contact the outer portion and/or a portion of a sticking transition (e.g., first sticking transition 207a). In some embodiments, the solid foam can be disposed so that it ultimately contacts the spacer and/or the frame. In some embodiments, the solid foam can be attached to the outer portion of the first fiberglass doorskin, for example, using a glue.

Step 1006 can provide an alternative method to step 906 for disposing foam adjacent the outer portion of the first fiberglass doorskin between the frame and the spacer (step 3). Step 1006 can include injecting foam adjacent the outer portion of the first fiberglass doorskin between the frame and the spacer. “Injecting component X between component Y and component Z” should not be interpreted to strictly mean injecting component X between component Y and component Z in a single step. Rather, “injecting component X between component Y and component Z” can refer to injecting component X at any location, such that at any point in time after component Y and component Z are disposed at their respective locations, component X is between component Y and component Z.

In some embodiments, the injected foam can comprise an expandable foam. In some embodiments, the expandable foam can comprise a polyurethane foam. In some embodiments, the expandable foam can comprise a polyethylene foam. In some embodiments, the expandable foam can comprise a light-density open-cell spray foam, a medium density closed-cell spray foam, and/or a high-density closed-cell spray foam. Injecting an expandable foam can reduce the cost and/or time required to fill the space between outer portions of the first and second fiberglass doorskins.

In some embodiments, injecting the foam adjacent the outer portion can comprise injecting the foam onto the outer portion. In some embodiments, the foam can be injected and allowed to expand to contact the first fiberglass doorskin and a second fiberglass doorskin, the frame, and/or the spacer.

In some embodiments, a second fiberglass doorskin (e.g., second doorskin 202b) can be attached to the frame before step 1006. In such embodiments, the injected foam can be injected in between the first and second fiberglass doorskins and between the frame and the spacer. In such embodiments, method 1000 can include leaving or creating an access port for the injection of the foam. For example, in some embodiments, method 1000 can include boring one or more holes in an outer portion of the first and/or second fiberglass doorskin for the injection of expandable foam. Alternatively or additionally, in some embodiments, method 1000 can include boring one or more holes in the frame for the injection of expandable foam. Alternatively or additionally, in some embodiments, method 1000 can include leaving a gap in the frame for the injection of expandable foam. Method 1000 can include sealing the one or more holes or gap in the first fiberglass doorskin, second fiberglass doorskin, and/or frame after injecting the foam.

Steps 908 and 1008 can include attaching an outer portion (e.g., second outer portion 204b) of a second fiberglass doorskin (e.g., second doorskin 202b) to the frame. In some embodiments, the outer portion of the second fiberglass doorskin can be attached to the frame using an adhesive, such as a glue. Alternatively or additionally, in some embodiments, the outer portion of the second fiberglass doorskin can be attached to the frame using screws, nails, tacks, bolts, etc. Once the outer portion of the second fiberglass doorskin is attached to the frame, the spacer and the foam can be between the first and second fiberglass doorskins.

In some embodiments, the first fiberglass doorskin and/or the second fiberglass doorskin can include multiple panel portions (e.g., multiple first or second panel portions 206a, 206b, respectively). In such embodiments, method 900 and/or method 1000 can include aligning multiple spacers (e.g., two or more of first, second, and third spacers 112a-c) with the multiple panel portions.

In method 900 and method 1000, the first and second fiberglass doorskins should be arranged such that panel portions of the first and second fiberglass doorskins, which are recessed from outer portions of the first and second fiberglass doorskins, extend toward one another. In other words, the recesses in the first and second fiberglass doorskins formed by panel portions should face away from one another. Accordingly, spacer(s) disposed within the resulting interior door can be pressed between panel portions of the first and second fiberglass doorskins. The panel portions and spacer(s) can form panels recessed from the remainder of the resulting interior door.

The first and second fiberglass doorskins of method 900 and 1000 can be formed using compression molding. For example, a segment of raw material (e.g., SMC or a glass-reinforced plastic) can be placed in a die, heated, and pressed into a desired shape. The desired shape can correspond to any configuration of first or second doorskin 202a, 202b described herein.

The use of fiberglass (e.g., a SMC that includes glass fibers) can allow for more defined features on a doorskin. By using fiberglass, a sticking transition between an outer portion or interior stile/rail portion and a panel portion can be close to perpendicular to a plane of the outer portion, interior stile/rail portion, and/or panel portion. As compared to other moldable materials such as medium-density fiberboard (MDF), fiberglass requires a smaller draft angle for removal from a die after molding. Protrusions in the die that form panel portion(s) of a doorskin can therefore be close to perpendicular to surfaces of cavities in the die that form outer portions or interior stile/rail portions. A resulting molded doorskin can produce a realistic facsimile of a wood shaker door, which typically includes sticking transition angles of 90 degrees between stiles/rails and panels.

Additionally, the use of fiberglass can increase the fire resistance of an interior door, as compared to a wood door. For example, in some embodiments, an interior door including the features described herein can exhibit a flame spread index below 25 when tested according to the ASTM E84-21a test method.

Additionally, the use of fiberglass can reduce the cost required to manufacture an interior shaker door, as compared to using wood. Simultaneously, the durability of the interior shaker door can be greater than a corresponding wood shaker door.

The use of cardboard (e.g., corrugated cardboard) or a wood composite (e.g., OSB) for a spacer as described herein can contribute to maintaining proper dimensions of a resulting door. For example, a cardboard or wood composite spacer does not expand or contract as much as foam, preserving proper panel thickness. Additionally, a cardboard spacer is more forgiving if panel dimensions or foam filler dimensions are manufactured incorrectly, since the cardboard spacer can be trimmed or compressed.

The foregoing description of the specific embodiments described with reference to the figures will so fully reveal the general nature of the disclosure that others can, by applying knowledge within the skill of the art, readily modify or adapt for various applications such specific embodiments, without undue experimentation, without departing from the general concept of this disclosure.

While various embodiments of this disclosure have been described above, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of this disclosure. The elements of the embodiments presented above are not necessarily mutually exclusive, but can be interchanged to meet various needs as would be appreciated by one of skill in the art.

It is to be understood that the phraseology or terminology used herein is for the purpose of description and not of limitation. The breadth and scope of this disclosure should not be limited by any of the above-described exemplary embodiments but should be defined only in accordance with the following claims and their equivalents.

It is to be appreciated that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

What is claimed is:

1. An interior door comprising:
a frame having first and second sides and defining outer lateral sides of the interior door;
first and second fiberglass doorskins attached to the first and second sides of the frame, respectively, each doorskin comprising an outer portion and a panel portion recessed from the outer portion;
a spacer between the panel portions of the first and second fiberglass doorskins; and
foam between the outer portions of the first and second doorskins.

2. The interior door of claim 1, wherein the spacer fills a volume defined by the panel portions of the first and second fiberglass doorskins.

3. The interior door of claim 2, where the spacer fills substantially the entire volume defined by the panel portions of the first and second fiberglass doorskins.

4. The interior door of claim 1, wherein the spacer contacts the first and second fiberglass doorskins.

5. The interior door of claim 1, wherein the foam contacts the first and second fiberglass doorskins.

6. The interior door of claim 1, wherein the foam contacts the frame and the spacer.

7. The interior door of claim 1, wherein the foam fills a volume defined by the outer portions of the first and second fiberglass doorskins, sticking transitions of the first and second fiberglass doorskins, and the frame.

8. The interior door of claim 7, where the foam fills substantially the entire volume defined by the outer portions of the first and second fiberglass doorskins, sticking transitions of the first and second fiberglass doorskins, and the frame.

9. The interior door of claim 8, wherein the first and second fiberglass doorskins each comprise a sticking transition between the outer portion and the panel portion, the sticking transition being planar and defining an angle relative to a plane of the outer portion of greater than about 70 degrees.

10. The interior door of claim 9, wherein the angle is between about 75 degrees and about 90 degrees.

11. The interior door of claim 1, wherein the panel portion is recessed from the outer portion by a depth between about 0.3 inches and about 0.75 inches.

12. The interior door of claim 1, wherein the spacer comprises cardboard.

13. The interior door of claim 12, wherein the cardboard comprises corrugated cardboard.

14. The interior door of claim 1, wherein the spacer comprises a wood composite.

15. The interior door of claim 1, wherein the frame comprises a wood composite.

16. The interior door of claim 15, wherein the wood composite comprises laminated veneer lumber (LVL).

17. The interior door of claim 1, wherein the foam comprises expanded polystyrene (EPS).

18. The interior door of claim 1, wherein each of the first and second fiberglass doorskins comprises a plurality of panel portions recessed from the outer portion.

19. The interior door of claim 1, wherein the interior door exhibits a flame spread index below 25 when tested according to the ASTM E84-21a test method.

20. A method of manufacturing an interior shaker door using fiberglass, the method comprising:
attaching an outer portion of a first fiberglass doorskin to a frame;
disposing a spacer adjacent a panel portion of the first fiberglass doorskin, the panel portion of the first fiberglass doorskin being recessed relative to the outer portion of the first fiberglass doorskin;
disposing foam adjacent the outer portion of the first fiberglass doorskin between the frame and the spacer; and
attaching an outer portion of a second fiberglass doorskin to the frame,
wherein the spacer and the foam are between the first and second fiberglass doorskins.

21. The method of claim 20, wherein the first fiberglass doorskin and the second fiberglass doorskin each comprise a sticking transition between the respective outer portion and the respective panel portion that defines an angle relative to a plane of the respective outer portion of greater than about 70 degrees.

22. The method of claim 21, wherein the angle is between about 75 degrees and about 90 degrees.

23. The method of claim 21, wherein the panel portions of the first and second fiberglass doorskins are recessed from the respective outer portions of the first and second fiberglass doorskins by a depth between about 0.3 inches and about 0.75 inches.

24. The method of claim 20, wherein the disposing the foam comprises injecting an expandable foam.

25. The method of claim 20, wherein the disposing the foam comprises disposing a solid foam segment.

26. The method of claim 20, wherein the first fiberglass doorskin comprises multiple panel portions. the method further comprising aligning multiple spacers with the multiple panel portions.

27. The method of claim 20. wherein the spacer comprises wood or cardboard.
